(19) United States
(12) Patent Application Publication
(10) Pub. No.: US 2012/0195454 A1
(43) Pub. Date: Aug. 2, 2012

(54) EAR PAD

(75) Inventors: Hirokazu Nishihara, Saitama (JP); Ikuo Shinohara, Tokyo (JP)

(73) Assignee: Sony Corporation, Tokyo (JP)

(21) Appl. No.: 13/351,978

(22) Filed: Jan. 17, 2012

(30) Foreign Application Priority Data
Jan. 28, 2011 (JP) 2011-017156

(51) Int. Cl. H04R 1/10

(52) U.S. Cl. 381/373

(57) ABSTRACT

An ear pad includes an exterior body which is mounted on a headphone and is formed in a ring shape having a hollow internal space, at least a contact surface of the exterior body with a user's temporal region having air permeability when the headphone is worn; and air permeable members placed in the exterior body.

### BACKGROUND

The present technology relates to an ear pad, and particularly, to an ear pad as a cushioning member provided in a headphone or the like.

To date, headphones have been used to listen to sound output from various sound reproduction devices such as a portable music player and a television receiver. Headphones typically include a headband that is to be in contact with a user's head, and a pair of housings for housing sound output means including a driver unit and the like, the housings being provided at respective right and left ends of the headband. In addition, on the side of each housing that faces the temporal region of a user's head, there is provided an ear pad as a cushioning member which prevents the housing from being in direct contact with the temporal region.

The ear pad serves as a cushioning member which reduces a user's feeling of discomfort caused by the contact between the user's ear, the temporal region and the headphones when they are worn by the user. Furthermore, the ear pad is normally configured to have high air tightness when applied to a user's ear by a cushioning material such as urethane and sponge being covered with synthetic leather or the like. The ear pad has high air tightness, and thus noise from the outside is blocked by sealing the space between a user's temporal region and the ear pad, and consequently, the ear pad also serves to make it easy for the user to hear the sound from the driver unit. In addition, the ear pad also serves to prevent the sound of the driver unit from being heard outside.

However, on the other hand, high air tightness of the ear pad may also result in poor air permeability. Consequently, when headphones having such highly airtight ear pads are used for a long time, the periphery of the ears and the temporal region of a user may become humid, thereby causing discomfort to the user.

Thus, there has been proposed a headphone apparatus which is provided with a vent hole in a loudspeaker unit so that humidity in the opening of the ear pad for covering the ear is reduced (Japanese Unexamined Utility Model Registration Application Publication No. 62-61593).

### SUMMARY

According to the technology described in Japanese Unexamined Utility Model Registration Application Publication No. 62-61593, humidity in the opening of the ear pad for covering the ear may be reduced. However, there is an unsolved problem that the contact area between the ear pad and a user's skin may not be prevented from becoming humid.

Thus, it is desirable to provide an ear pad that can prevent such humidity.

According to an embodiment of the present technology, there is provided an ear pad which includes the following elements: an exterior body which is mounted on a headphone and is formed in a ring shape having a hollow internal space, at least a contact surface of the exterior body that is in contact with a user's temporal region being configured to have air permeability when the headphone is being worn; and an air permeable member placed in the exterior body.

According to an embodiment of the present technology, the ear and temporal region of a user which are in contact with the ear pad when a headphone is being worn may be prevented from becoming humid.

### BRIEF DESCRIPTION OF THE DRAWINGS

FIG. 1 is a diagram showing the external configuration of headphones having ear pads according to an embodiment of the present technology;

FIG. 2A is a sectional perspective view showing the internal configuration of the ear pad according to an embodiment of the present technology;

FIG. 2B is a sectional view of an exterior body constituting the ear pad;

FIG. 2C is a sectional view showing another example of the exterior body;

FIG. 3 is a sectional perspective view illustrating an air flow through and escape of sound from the ear pad;

FIG. 4 is a graph showing a result of comparison of the sound pressure sensitivity between the ear pad according to an embodiment of the present technology, and another ear pad configured to have air permeability over its entire surface; and

FIGS. 5A and 5B are side sectional views of an exterior body showing a modification of the ear pad according to an embodiment of the present technology.

### DETAILED DESCRIPTION OF EMBODIMENTS

Hereinafter, an embodiment of the present technology is described with reference to the accompanying drawings. However, the present technology is not limited to the following embodiments. Description is given in the following order.

### <1. Embodiment>

### [1-1. Configuration of Headphone]

### [1-2. Configuration of Ear Pad]

### <2. Modification>

### 1. Embodiment

### 1-1. Configuration of Headphone

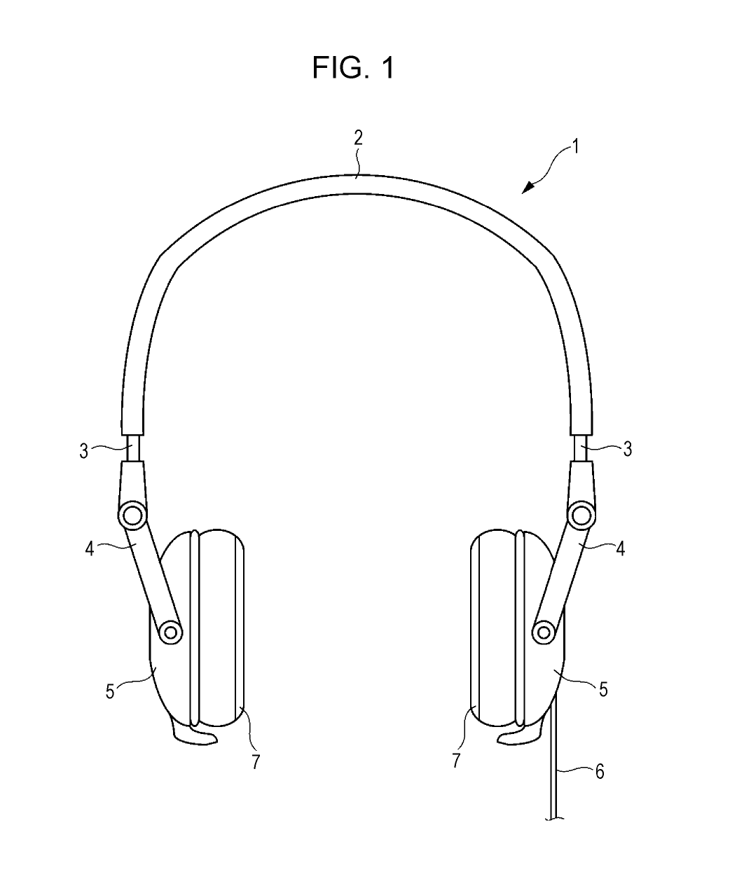

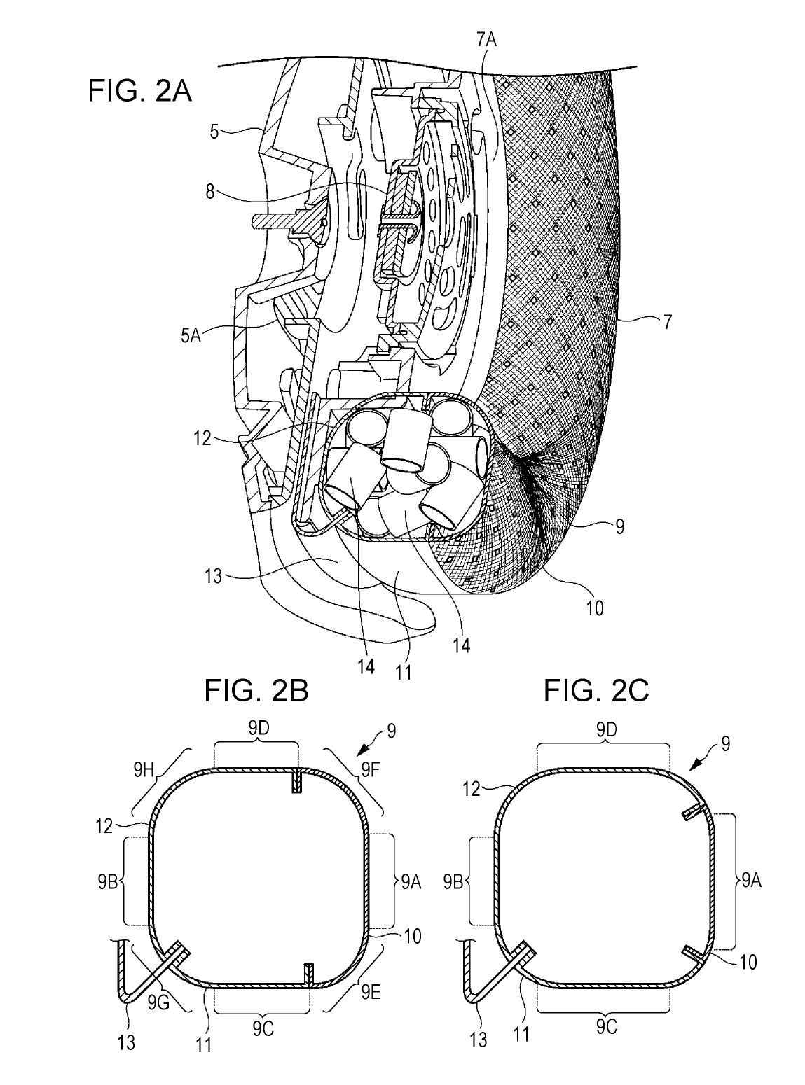

First, the configuration of headphones 1 is described with reference to FIGS. 1 and 2A to 2C. FIG. 1 is a diagram showing the external configuration of the headphones 1 having ear pads 7 according to an embodiment of the present technology. FIG. 2A is a sectional perspective view of a housing 5 and the ear pad 7 on the R channel side of the headphones 1. FIG. 2B is a side sectional view of an exterior body 9 constituting the ear pad. The housing 5 and the ear pad 7 on the L channel side are configured similarly to those on the R channel side.

The headphones 1 include a headband 2, sliders 3, 3, hangers 4, 4, the housings 5, 5, a cord 6, the ear pads 7, 7, and a driver unit 8 provided in each housing 5.

The headband 2 is formed in a curved shape so as to fit along a user's head, and thus the entirety of the headphones 1 is supported by the contact of the headband 2 with the top of the user's head when the headband 2 is worn. The headband 2 is formed with a synthetic resin such as plastic, metal, or the like, and thus has flexibility because of having a predetermined rigidity and elasticity. Accordingly, when the headphones 1 are worn, the headband 2 presses the housings 5 and the ear pads 7 in the direction of the user's temporal regions so that the headphones 1 remain in the original state. In addition, rubber or the like may be installed as a cushioning material in a portion of the inner surface of the headband 2, which is made to contact the top of a user's head. Alternatively, a hinge may be installed in the headband 2 so that the headband may be folded in the middle for portable use.

Each of the both ends of the headband 2 is provided with the slider 3. Then the slider 3 is provided with the hanger 4. The slider 3 is slidably disposed within the headband 2. The hanger 4 may be moved up or down with respect to the headband 2 by sliding the slider 3 within the headband 2. When the headphones 1 are worn by a user, the housings 5 and the ear pads 7 may be each adjusted to a position facing one of the user's ears by adjusting an extension/contraction length of each of the sliders 3 in accordance with the size of the user's head and/or the distances between the user's ears and the top of the user's head. Accordingly, the user may have a comfortable wearing feeling in accordance with the physical characteristics or a preference of the user. On the other hand, when the headphones 1 are not used, the space required for storing the headphones 1 may be reduced by contracting the sliders 3.

The hangers 4 are each provided at the end of the respective slider 3, and the housing 5 is rotatably supported by the hanger 4. The housing 5 is pivotally supported by the hanger 4, for example, with supporting pins (not shown) inwardly projecting respectively from a pair of ends so as to be rotatably supported. Accordingly, when the headphones 1 are worn by a user, the orientations of the housings 5 vary according to the shapes of the user's ears and temporal regions, and thus the housings 5 may be fitted to the ears in a suitable manner to the shapes of the user's temporal regions.

The housings 5 each serve as a housing to internally house the driver unit 8 or the like which is a sound output unit for converting an electric signal to a sound wave to be output. The housing 5 is formed with a synthetic resin such as plastic. On the opposite side to the surface of the housing 5 to which the ear pad 7 is attached, a plurality of sound escape holes 5A are formed that allow sound to escape from the rear surface of the driver unit 8 through the housing 5. However, the sound escape holes 5A may not be necessarily provided. In the case where the headphones 1 are formed as what is called open air type (open type) headphones, the sound escape holes may be preferably provided in the housings 5. On the other hand, in the case where the headphones 1 are formed as what is called closed type (sealed type) headphones, the sound escape holes may not be provided in the housings 5.

The cord 6 includes a lead wire L for the left channel, a lead wire R for the right channel, a ground line G, and the like that are internally inserted thereinto, and is configured to transmit sound signals to the headphones 1 from a sound reproduction device (not shown) such as a portable music player or a television receiver. One end of the cord 6 is connected to the driver unit 8 that is housed in one of the pair of housings 5. On the other hand, the other end of the cord 6 is provided with a plug (not shown). The headphones 1 are connected to the sound reproduction device by connecting the plug thereto.

In order to drive the driver unit 8 in the other housing 5 to which the cord 6 is not connected, a connecting cord (not shown) is provided between the housing 5 that is connected to the cord 6, and the other housing 5 that is not connected to the cord 6. The connecting cord is connected to the cord 6, or the driver unit 8 in the housing 5 connected to the cord 6, while being connected to the driver unit 8 in the other housing 5 through the inside of the hangers 4, the sliders 3, and the headband 2. A sound signal is transmitted via the connecting cord to the driver unit 8 in the other housing 5 that is not connected to the cord 6. However, a configuration may be adopted in which two cords are connected to the left and right housings 5, respectively, so as to supply a sound signal to the respective driver units 8 in the both left and right housings 5.

The ear pads 7 are each provided on the surface opposite to the side of the housing 5 that faces a user's temporal region. The ear pad 7 serves as a cushioning member between the housing 5 and a user's temporal region by interposing itself therebetween. That is to say, when the headphones 1 are worn by a user, the ear pads 7 prevent the housings 5 from coming into direct contact with the user's ears and temporal regions and causing discomfort and pain to the user, the housings 5 being composed of a rigid deformation resistant material.

In addition, the ear pads 7 also serve to improve sound quality such as the reproduction quality of low audio frequencies by preventing sound from escaping. Furthermore, the ear pads 7 also serve to prevent the sound outputted from the driver units 8 from escaping to the outside. Furthermore, the ear pads 7 also serve to facilitate hearing of the sound from the driver units 8 by blocking noise from the outside.

A protection net may be provided between the ear pad 7 and the housing 5. The protection net is for preventing entry of dust into the driver unit 8 and the like that are housed in the housing 5.

### 1-2. Configuration of Ear Pad

The ear pad 7 is formed in a ring shape that is substantially circular in plan view and has an opening 7A for covering a user's ear in the center. The ear pad 7 includes an exterior body formed in a ring shape having a hollow internal space, a connector 13 for connecting the ear pad 7 to the housing 5, and a plurality of small pieces 14, 14 that fill the exterior body 9.

In the present embodiment, the exterior body 9 is formed so as to have a substantially octagonal shape in cross section as shown in FIGS. 2A and 2B. In the following description, out of the eight surfaces of the exterior body 9, the surface that comes into contact with a user's temporal region when the headphones 1 are worn by the user is referred to as a contact surface 9A, the surface opposite to the contact surface 9A, closer to the housing is referred to as a base surface 9B, the surface on the outer circumference of the exterior body 9 is referred to as an outer circumferential surface 9C, and the surface on the inner circumference of the exterior body 9 is referred to as an inner circumferential surface 9D. Furthermore, out of four inclined surfaces of the exterior body 9, the surface on the outer circumference, closer to the contact surface 9A is referred to as a contact-side outer circumferential inclined surface 9E, the surface on the inner circumference, closer to the contact surface 9A is referred to as a contact-side inner circumferential inclined surface 9F, the surface on the outer circumference, closer to the base surface 9B is referred to as a base-side outer circumferential inclined surface 9G, and the surface on the inner circumference, closer to the base surface 9B is referred to as a base-side inner circumferential inclined surface 9H.

The exterior body 9 includes a first exterior portion 10, a second exterior portion 11, and a third exterior portion 12. The first exterior portion 10 includes the contact surface 9A in the exterior body 9. The first exterior portion 10 is formed with a thin material, for example, mesh-processed cloth, or mesh-processed synthetic leather, and thus is configured to have air permeability. Alternatively, the thin material such as cloth or leather may be configured to have air permeability by forming a great number of permeable pores therein. Alternatively, the first exterior portion 10 may be configured to have air permeability by forming the thin material using raw material having air permeability because of having, for example, a special structure such as a honeycomb structure. That is to say, the thin material to be used to form the first exterior portion 10 may be any material, provided that it has air permeability and a texture which causes no discomfort to a user when the material is in contact with the user's ear and temporal region.

The second exterior portion 11 includes the outer circumferential surface 9C of the exterior body 9. The third exterior portion 12 includes the base surface 9B and the inner circumferential surface 9 of the exterior body 9. The second exterior portion 11 and the third exterior portion 12 are formed with, for example, a thin material composed of a highly airtight raw material such as natural leather or synthetic leather.

The first exterior portion 10, the second exterior portion 11, and the third exterior portion 12 have respective inwardly bent ends in the longitudinal direction. The adjacent bent portions are then connected, for example, by stitching them together. Accordingly, the exterior body 9 is formed in a ring shape having a hollow internal space.

Specifically, one end of the first exterior portion 10 and one end of the second exterior portion 11 are connected to each other. In addition, the other end of the second exterior portion 11 and one end of the third exterior portion 12 are connected to each other. Furthermore, the other end of the third exterior portion 12 and the other end of the first exterior portion 10 are connected to each other.

In this manner, in the present embodiment, the exterior body 9 is formed by connecting three members: the first exterior portion 10, the second exterior portion 11, and the third exterior portion 12. A configuration allowing at least the contact surface 9A to have air permeability may be easily achieved by forming one of the three exterior portions (the first exterior portion 10 in the present embodiment) so as to have air permeability. Accordingly, the product according to an embodiment of the present technology may be manufactured quickly and easily.

In addition to the contact surface 9A, another surface may be configured to have air permeability. This configuration is described with reference to FIG. 2B.

As shown in FIG. 2B, the exterior body 9 includes the contact surface 9A, the base surface 9B, the outer circumferential surface 9C, the inner circumferential surface 9D, the contact-side outer circumferential inclined surface 9E, the contact-side inner circumferential inclined surface 9F, the base-side outer circumferential inclined surface 9G, and the base-side inner circumferential inclined surface 9H so that the exterior body 9 has a substantially octagonal shape in cross section. In addition to the contact surface 9A, for example, all or part of the contact-side outer circumferential inclined surface 9E, and/or all or part of the outer circumferential surface 9C may be configured to have air permeability when the exterior body 9 has a substantially octagonal shape in cross section. Furthermore, all or part of the contact-side inner circumferential inclined surface 9F, and/or all or part of the inner circumferential surface 9D may be configured to have air permeability.

In the exterior body 9 shown in FIG. 2B, in addition to the contact surface 9A, all of the contact-side outer circumferential inclined surface 9E and all of the contact-side inner circumferential inclined surface 9F are configured to have air permeability. With this configuration, when the headphones 1 are worn by a user, the opening 7A and the outside constantly communicate with each other through the contact-side outer circumferential inclined surface 9E and the contact-side inner circumferential inclined surface 9F, which have air permeability even when the contact surface 9A having air permeability is blocked by the user's ear and temporal region. Accordingly, high air permeability may be maintained constantly.

By adopting a configuration in which the contact-side outer circumferential inclined surface 9E and the contact-side inner circumferential inclined surface 9F that are adjacent to the contact surface 9A have air permeability, the contact surface 9A, the contact-side outer circumferential inclined surface 9E, and the contact-side inner circumferential inclined surface 9F may be formed of a single member. Accordingly, an ear pad having air permeability may be easily formed. In the present embodiment, as shown in FIGS. 2A and 2B, the contact surface 9A, the contact-side outer circumferential inclined surface 9E, and the contact-side inner circumferential inclined surface 9F are formed of the first exterior portion 10.

The above description is not intended to exclude a configuration that allows only the contact surface 9A to have air permeability. That is to say, as shown in FIG. 2C, only the contact surface 9A may be configured to have air permeability. Even with this configuration, the contact surface 9A may be prevented from becoming humid. Alternatively, the contact surface 9A and all or part of the surface adjacent to the contact surface 9A may be configured to have air permeability.

However, an excessive increase in the size of the portion having air permeability in the exterior body results in an increase in the amount of sound that escapes from the exterior body. Accordingly, sound quality, particularly reproduction quality of low-frequency sound will deteriorate. Consequently, the size of the portion having air permeability should be determined as appropriate so as to maintain the air permeability of the exterior body 9, while the escape of sound is reduced to a minimum.

Now returning to the description of the configuration of the ear pad 7, the exterior body 9 includes the connector 13 for connecting the ear pad 7 to the housing 5. In the present embodiment, one end of the connector 13 is inserted between the bent portion of the second exterior portion 11, and the bent portion of the third exterior portion 12, and the connector 13 is secured to the exterior body 9 by stitching together the bent portions and the connector 13 interposed therebetween.

The connector 13 is provided on the side of the ear pad 7, closer to the housing 5, and is formed so as to have a substantially U-shaped cross section and so as to be open in the direction toward the center of the ear pad 7. The connector 13 is formed so as to extend in the direction toward the housing 5 so that the end of the connector 13 faces in the direction toward the center of the ear pad 7. Then by inserting the extending portion toward the center of the ear pad 7 into an attachment groove (not shown) for the ear pad which is formed around the outer circumference of the housing 5, the ear pad 7 is fixed to the housing 5. The ear pad 7 may also be removed from the housing 5 in order to be replaced. Similarly to the second exterior portion 11 and the third exterior portion 12, the connector 13 is formed with natural leather, synthetic leather, or the like. However, the configuration of the connector 13 is not limited to such a configuration. As long as the ear pad 7 can be connected to the housing 5, any configuration may be used.

The inside of the exterior body 9 is filled with a plurality of small pieces 14 as air permeable members. In the present embodiment, the small pieces 14 are each formed as a low-height cylindrical body having a hole. In addition, the small pieces 14 are configured to have flexibility or elasticity, for example, using polyethylene as a material.

Materials that may be used for forming the small pieces 14 may be any material having flexibility or elasticity, such as polypropylene, polyethylene terephthalate, silicon, vinyl chloride resin, or nylon, in addition to polyethylene. However, in order to reduce the burden of the weight of the headphones 1 to a user, the small pieces 14 are preferably lightweight. In order for the exterior body 9 to maintain the shape of the ear pad 7, an appropriate amount of the small pieces 14 may be filled therein. The ear pad 7 according to an embodiment of the present technology is configured in the above manner.

For example, in the case where the first exterior portion 10 is formed with mesh-processed cloth, from the perspective of design, the second exterior portion 11, the third exterior portion 12, and the connector 13 may be covered with mesh-processed cloth similarly to the first exterior portion 10. In addition, the first exterior portion 10, the second exterior portion 11, the third exterior portion 12, and the connector 13 may have the same color. Accordingly, an ear pad having an integrated aesthetic appearance may be achieved in such a manner that the first exterior portion 10, the second exterior portion 11, the third exterior portion 12, and the connector 13 are all formed with mesh-processed cloth.

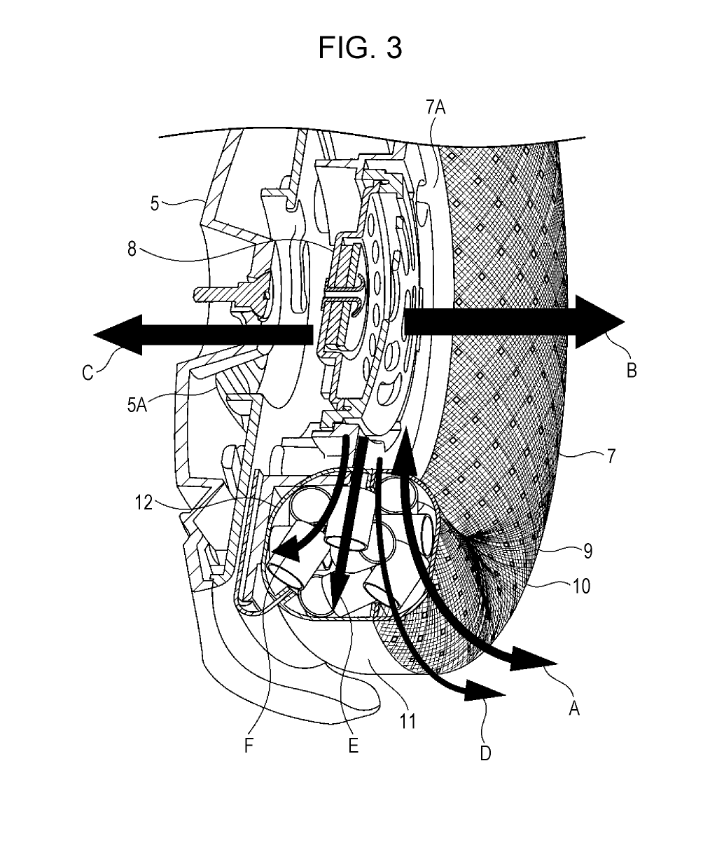

Next, air permeability of the ear pad 7 according to an embodiment of the present technology is described with reference to FIG. 3. The inside of the exterior body 9 is filled with a plurality of small pieces 14, and thus many spaces are formed between the small pieces 14. Furthermore, the first exterior portion 10 is configured to have air permeability, the first exterior portion 10 including the contact surface 9A, the contact-side outer circumferential inclined surface 9E, and the contact-side inner circumferential inclined surface 9F in the exterior body 9. An air flow as indicated by the arrow A may be generated between the opening 7A and the outside through the spaces between the small pieces 14, and the first exterior portion 10 having air permeability. Accordingly, the opening 7A for covering a user's ear and the contact surface 9A of the exterior body 9 may be prevented from becoming humid.

Furthermore, the small pieces 14 are each formed in a cylindrical shape having a through hole, and thus an air flow may also be generated through the hole. Accordingly, air permeability of the ear pad 7 further increases, and thus the space between the ear pad 7 and a user's ear and temporal region may be more securely prevented from becoming humid.

Next, the escape of sound from the ear pad 7 is described. When sound is output from the driver unit 8, the sound is directly transmitted to a user's ear through the opening 7A of the ear pad 7 as indicated by the arrow B in FIG. 3. As indicated by the arrow C, the sound escapes from the rear surface of the driver unit 8 even through the sound escape hole 5A of the housing 5.

The first exterior portion 10 is configured to have air permeability, while the inside of the exterior body 9 is filled with a plurality of small pieces 14 having air permeability. Accordingly, as indicated by the arrow D, a slight amount of sound escapes through the small pieces 14 in the ear pad 7 and the first exterior portion 10.

On the other hand, the second exterior portion 11 and the third exterior portion 12 are formed with a highly airtight material such as synthetic leather. Accordingly, as indicated by the arrows E and F, the sound from the driver unit 8 is blocked by the second exterior portion 11 and the third exterior portion 12. Consequently, sound does not escape from the surface including the second exterior portion 11 and third exterior portion 12 portion. Accordingly, undesired escaping of sound is prevented, and sound quality, particularly reproduction quality of low audio frequencies may be maintained.

In this manner, in the ear pad 7 according to an embodiment of the present technology, the inside of the exterior body 9 is filled with air permeable members having air permeability. In addition, the first exterior portion 10 including at least the contact surface 9A is configured to have air permeability. Furthermore, the second exterior portion 11 and the third exterior portion 12 are configured to have air tightness. Accordingly, preventing humidity and maintaining the sound quality by reducing undesired escaping of sound to a minimum may be achieved at the same time.

In the present embodiment, the small pieces 14 are formed with a raw material having flexibility or elasticity, such as polyethylene, and are constructed in a cylindrical shape. Consequently, when the headphones 1 are worn by a user, the ear pads 7 are deformed in accordance with the projections/depressions of the user's ears and temporal regions. Accordingly, even when the headphones 1 are worn for a long time, the ear pads 7 do not apply a pressure to the user's ears and temporal regions, thereby causing no discomfort to the user. In addition, the ear pads 7 are deformed in accordance with the projections/depressions of the user's ears and temporal regions, and thus excessive spaces between the projections/depressions of the user's ears, temporal regions and the ear pads 7 are prevented from being created, and thus undesired escaping of sound and interference of noise may be prevented.

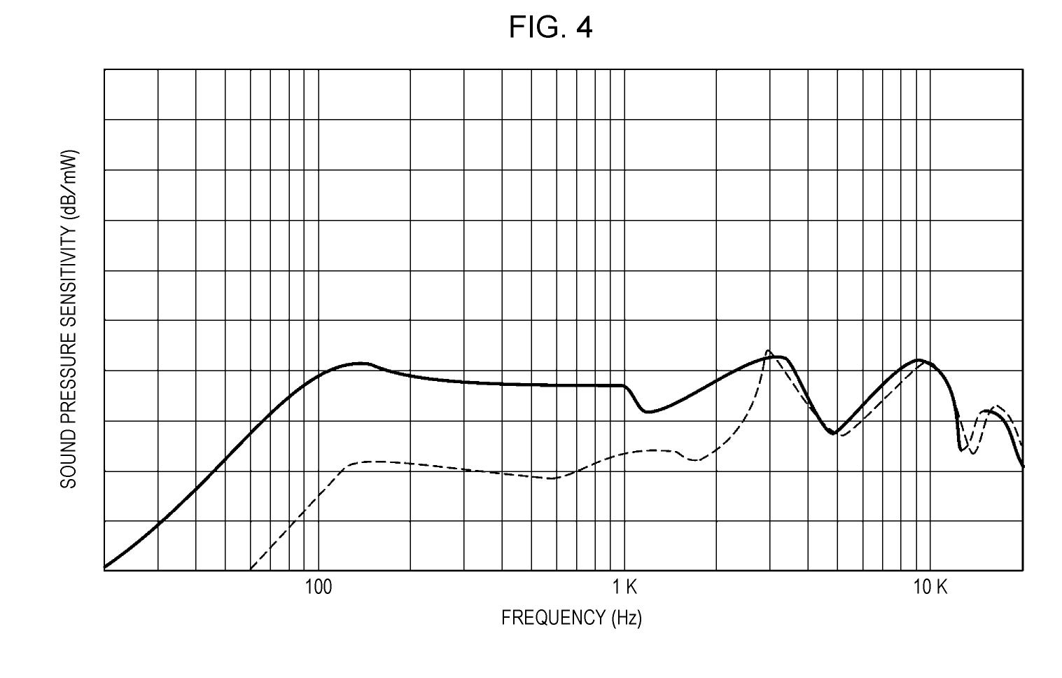

FIG. 4 is a graph showing results of comparison of the sound pressure sensitivity between the ear pad according to an embodiment of the present technology, and another ear pad configured to have air permeability over the entire exterior surface thereof, where the horizontal axis represents the frequency (Hz) and the vertical axis represents the sound pressure sensitivity (dB/mW). One unit on the vertical axis of the graph in FIG. 4 represents 5 dB. A comparison of the sound pressure sensitivity was made between the ear pad according to an embodiment of the present technology, and the ear pad having air permeability over its entire surface that have been described in the above embodiment. The two ear pads were attached to respective headphones each having a headband to be worn on a user's head as shown in FIG. 1, and the same sound was outputted to the headphones and the outputted sound was measured.

In FIG. 4, the characteristics of the ear pad according to an embodiment of the present technology is shown by the solid line, and the characteristics of the ear pad that is configured to have air permeability over the entire surface of the exterior body thereof is shown by the dashed line, the inside of the exterior body being filled with small polyethylene cylindrical bodies as air permeable members.

The ear pad configured to have air permeability over its entire surface has reduced sound pressure sensitivity at low audio frequencies. On the other hand, the ear pad according to an embodiment of the present technology has a sound pressure sensitivity that is higher than that of the ear pad configured to have air permeability over its entire surface by approximately 10 dB at low audio frequencies. Furthermore, at high audio frequencies, the ear pad according to an embodiment of the present technology has sound pressure sensitivity characteristics almost equivalent to those of the ear pad that is configured to have air tightness (no air permeability) over its entire surface.

Consequently, compared with the ear pad configured to have air permeability over the entire surface of the exterior body thereof, the ear pad according to an embodiment of the present technology has superior sound quality (particularly, sound reproduction quality in low audio frequencies). This feature is achieved because in the present technology, the ear pad is not configured to have air permeability over the entire surface of the exterior body thereof, but is configured to have air permeability over part of the surface and not to have air permeability over the rest of the surface.

The characteristics shown by the solid line indicate that at all frequencies, the ear pad according to an embodiment of the present technology has sound pressure sensitivity characteristics almost equivalent to those of open type headphones, in which the ear pad configured to have air tightness over the entire surface of the exterior body thereof is used. Consequently, compared with the ear pad configured to have air permeability over the entire surface of the exterior body thereof, the ear pad according to an embodiment of the present technology has superior sound quality such as in terms of sound reproduction quality at low audio frequencies, while preventing humidity and achieving sound pressure sensitivity equivalent to that of the ear pad configured to have air tightness over the entire surface of the exterior body thereof.

In the present embodiment, a plurality of small pieces 14 as air permeable members are formed as cylindrical bodies composed of polyethylene, however, it is possible to use small pieces having a non-cylindrical shape as air permeable members. Hereinafter, the results of reviewing of the small pieces used as air permeable members are described.

<Sample 1>

The exterior body included a total of three exterior portions: the first exterior portion, the second exterior portion, and the third exterior portion. Then, the first exterior portion was formed with mesh-processed cloth, and the second exterior portion and the third exterior portion were formed with synthetic leather. Then, an ear pad was formed by filling the inside of the exterior body with a plurality of cylindrical bodies composed of polyethylene as the small pieces.

<Sample 2>

An ear pad was fabricated similarly to Sample 1 except for the following step: a commercial straw was cut into pieces having a low-height cylindrical shape, having a predetermined height (hereinafter, referred to as a straw-cut bodies), and the inside of the exterior body was filled with a plurality of the straw-cut bodies.

<Sample 3>

An ear pad was fabricated similarly to Sample 1 except for the following step: the inside of the exterior body was filled with buckwheat husks.

<Sample 4>

An ear pad was fabricated similarly to Sample 1 except for the following step: the inside of the exterior body was filled with a plurality of beads composed of polypropylene.

<Sample 5>

An ear pad was fabricated similarly to Sample 1 except for the following step: the inside of the exterior body was filled with a plurality of circular hard plastic pieces.

The above Samples 1 to 5 were reviewed in terms of the following aspects: weight, wearing feeling, noise, sound quality, humidity feeling. The review was made by actually using headphones having the ear pads of each of the above Samples.

The weight as a review item refers to reviewing the weight of an ear pad when the inside of the exterior body is filled with a sufficient amount of the small pieces to maintain the shape of the ear pad. Headphones are usually used for a long time, and thus are preferably lightweight.

The wearing feeling as a review item refers to reviewing whether or not contact of the ear pads with a user's ears is favorable, i.e., whether or not indirect contact of the small pieces with the user's ears and temporal regions via the exterior bodies may cause discomfort to the user, and whether or not hardness of the small pieces may cause pain to the user when the headphones are worn by the user.

The noise as a review item refers to reviewing the noise that may be generated by the small pieces in the ear pads. When the inside of the exterior body is filled with a plurality of the small pieces, noise may occur due to rubbing of the small pieces against each other. Noise has an adverse effect on the user's hearing of the sound output from the headphones, and thus low noise is preferable.

The sound quality as a review item refers to reviewing a change in sound quality due to escaping of sound, particularly, reproduction quality of low sound. The humidity feeling as a review item refers to reviewing the degree of humidity of a user's ears and temporal regions which are in contact with the ear pads when headphones are worn by the user.

The test results are shown in Table 1.

| | | WEARING | | SOUND | HUMIDITY |
|---|---|---|---|---|---|
| | WEIGHT | FEELING | NOISE | QUALITY | FEELING |
| SAMPLE 1 | EXCELLENT | EXCELLENT | EXCELLENT | EXCELLENT | EXCELLENT |
| POLYETHYLENE | | | | | |
| CYLINDRICAL | | | | | |
| BODY | | | | | |
| SAMPLE 2 | EXCELLENT | GOOD | EXCELLENT | EXCELLENT | EXCELLENT |
| STRAW-CUT | | | | | |
| BODY | | | | | |
| SAMPLE 3 | FAIR | EXCELLENT | FAIR | GOOD | FAIR |
| BUCKWHEAT | | | | | |
| HUSK | | | | | |
| SAMPLE 4 | FAIR | GOOD | GOOD | GOOD | GOOD |
| BEAD | | | | | |
| SAMPLE 5 | EXCELLENT | FAIR | GOOD | EXCELLENT | EXCELLENT |
| CIRCULAR | | | | | |
| HARD PLASTIC | | | | | |

Regarding the weight, the test results were obtained that the cylindrical body, the straw-cut body, and the circular hard plastic are lightweight and favorable.

Regarding the wearing feeling, the test results were obtained that the cylindrical body, and particularly the buckwheat husk are favorable, and the straw-cut body and the bead are the second-most favorable.

Regarding the noise, the test results were obtained that the cylindrical body and the straw-cut body have low noise, and are thus especially favorable. The bead, and the circular hard plastic have the second-lowest noise, and thus favorable. This is because the cylindrical body and the straw-cut body that are composed of polyethylene have flexibility or elasticity, and thus even when the cylindrical bodies come into collision or contact with each other, friction sound is not likely to occur.

Regarding the sound quality, the test results were obtained that the cylindrical body, the straw-cut body, and the circular hard plastic have better reproduction of sound, particularly low-frequency sound, and thus are especially favorable. The buckwheat husk and the bead are the second-most favorable.

Regarding the humidity feeling, the test results were obtained that the cylindrical body, the straw-cut body, and the circular hard plastic cause low humidity, and thus are especially favorable. The bead is the second-most favorable.

From the results of the review above, it is desirable that the small pieces serving as air permeable members have air permeability and a lightweight, friction sound due to contact of the small pieces against each other is not likely to occur, and the small pieces have flexibility or elasticity. As long as these conditions are satisfied, any material and any shape may be used for the small pieces.

### 3. Modification

So far, an embodiment of the present technology has been specifically described, however, the present technology is not limited to the above-described embodiment. Various modifications based on the technical concept of the present technology may be made.

In the above-described embodiment, the exterior body 9 includes total of three exterior portions: the first exterior portion 10, the second exterior portion 11, and the third exterior portion 12. However, the exterior body 9 is not necessarily formed with three exterior portions.

The effect according to an embodiment of the present technology may be provided by one or two exterior portions. So long as the contact surface can achieve at least the exterior body having air permeability, the exterior body may be formed with one or two exterior portions.

In the above description, it has been assumed that the exterior body 9 has a substantially octagonal cross section. However, the sectional shape of the exterior body is not limited to a substantially octagonal shape.

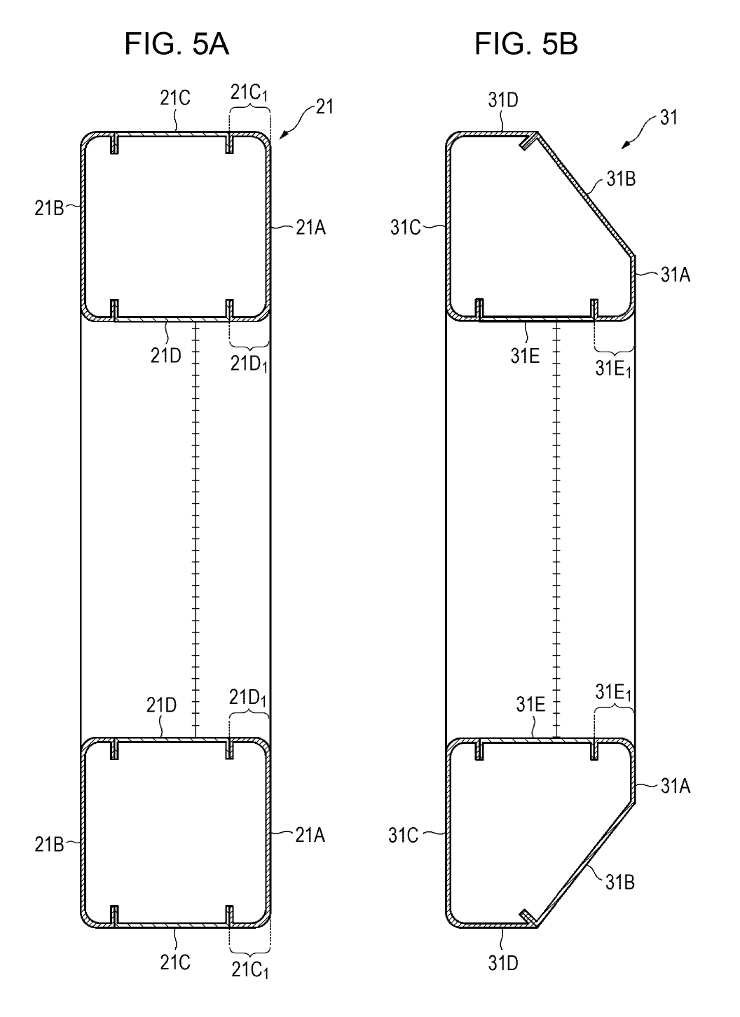

A modification of the exterior body is shown in FIG. 5.

FIG. 5A is a side sectional view of the exterior body according to a first modification. FIG. 5B is a side sectional view of the exterior body according to a second modification. In FIGS. 5A and 5B, the right side is the housing side, and the left side is the side with which a user's ear and temporal region are made to contact.

For example, as shown in FIG. 5A, the exterior body 21 may includes a contact surface 21A, a base surface 21B, an outer circumferential surface 21C, and an inner circumferential surface 21D so as to have a substantially rectangular cross section.

In this case, at least the contact surface 21A is configured to have air permeability. In addition to the contact surface 21A, a contact-side outer circumferential surface 21C₁ which is part of the outer circumferential surface 21C, closer to the contact surface 21A, and a contact-side inner circumferential surface 21D₁ which is part of the inner circumferential surface 21D, closer to the contact surface 21A may be configured to have air permeability. Accordingly, the inside of the opening of the ear pad and the outside communicate with each other through the contact-side outer circumferential surface 21C₁ and the contact-side inner circumferential surface 21D₁ even when the contact surface 21A is blocked by the user's ear or temporal region. Consequently, the air permeability of the ear pad can be improved.

In addition, the contact-side outer circumferential surface 21C₁ and the contact-side inner circumferential surface 21D₁ are adjacent to the contact surface 21A, and thus the contact surface 21A, the contact-side outer circumferential surface 21C₁, and the contact-side inner circumferential surface 21D₁ may be formed with a single member. Accordingly, an ear pad having air permeability may be easily formed.

Furthermore, as shown in FIG. 5B, the exterior body 31 may include a contact surface 31A, an inclined surface 31B, a base surface 31C, an outer circumferential surface 31D, and an inner circumferential surface 31E so as to have a substantially trapezoidal cross section. In this case, at least the contact surface 31A is configured to have air permeability. In addition to the contact surface 31A, the inclined surface 31B, and a contact-side inner circumferential surface 31E₁ which is part of the inner circumferential surface 31E, closer to the contact surface 31A may be configured to have air permeability.

Accordingly, the inside of the opening of the ear pad and the outside communicate with each other through the inclined surface 31B and the contact-side inner circumferential surface 31E₁ even when the contact surface 31A is blocked by the user's ear or temporal region. Consequently, the air permeability of the ear pad can be improved.

In addition, the inclined surface 31B and the contact-side inner circumferential surface 31E₁ are adjacent to the contact surface 31A, and thus the contact surface 31A, the inclined surface 31B, and the contact-side inner circumferential surface 31E₁ may be formed of a single member. Accordingly, an ear pad having air permeability may be easily formed.

In the above-described embodiment, a plurality of small pieces are shown by way of example as air permeable members, however, the air permeable members are not limited to a plurality of small pieces, and may be a single member in which a great number of permeable holes are formed. Alternatively, a granular piece which is smaller in size than the small piece shown in FIG. 2 may be used, and the inside of the exterior body may be filled with a great number of the granular pieces.

In the above-described embodiment, the case has been described as an example where the ear pad according to an embodiment of the present technology is applied to headphones having a headband to be worn on a user's head. However, the ear pad according to an embodiment of the present technology may be applied to a type of headphone in which the ear pad is hooked on a user's ear without using a headband so that the housing is mounted on the ear. In addition, the ear pad according to an embodiment of the present technology may also be applied to a headphone having a microphone, or what is called a headset.

The present disclosure contains subject matter related to that disclosed in Japanese Priority Patent Application JP 2011-017156 filed in the Japan Patent Office on Jan. 28, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An ear pad comprising:
an exterior body which is mounted on a headphone and is formed in a ring shape having a hollow internal space, wherein at least a contact surface of the exterior body with a user's temporal region is configured to have air permeability when the headphone is worn; and
an air permeable member placed in the exterior body.

2. The ear pad according to claim 1,
wherein the air permeable member includes plural small pieces, which are placed inside the exterior body so as to fill the inside thereof.

3. The ear pad according to claim 2,
wherein the small pieces are formed in a ring shape.

4. The ear pad according to claim 1,
wherein the air permeable member includes a material having flexibility or elasticity.

5. The ear pad according to claim 1,
wherein the exterior body includes:
a first exterior portion including the contact surface; and
a second exterior portion and a third exterior portion that include a surface other than surfaces included in the first exterior portion.
